(19) United States
(12) Patent Application Publication
(10) Pub. No.: US 2016/0120373 A1
(43) Pub. Date: May 5, 2016

(54) DENTAL PRODUCT HOLDER ASSEMBLIES

(71) Applicant: Dwight Wilson STRONG, Santa Fe, NM (US)

(72) Inventor: Dwight Wilson STRONG, Santa Fe, NM (US)

(21) Appl. No.: 14/530,830

(22) Filed: Nov. 3, 2014

(51) Int. Cl. A47K 5/00; F16M 11/04; A47K 1/09

(52) U.S. Cl. CPC A47K 5/00; A47K 1/09; F16M 11/04

(57) ABSTRACT

Devices and apparatuses of the present technology provide a distinct advantage in storing a toothpaste tube in such a way that handling (and storing) the toothpaste tube, by an individual, can occur with the use of just one hand. This is particularly useful for young and physically limited individuals who are have difficulty using both hands to manipulate or use a toothpaste tube effectively.

### CROSS REFERENCE TO RELATED APPLICATIONS

Not Applicable

### STATEMENT REGARDING FEDERAL SPONSORED RESEARCH OR DEVELOPMENT Not Applicable

### REFERENCE TO SEQUENCE LISTING, A TABLE, OR A COMPUTER PROGRAM

Not Applicable

### BACKGROUND

1. Field of Invention

Embodiments relate to dental product holders, and more particularly but not exclusively, to devices and assemblies, such as dental product holders that receive and support dental products. Example dental products include, but are not limited to, toothpaste tubes, toothbrushes, dental floss, electric tooth brush accessories, and so forth.

### BRIEF SUMMARY OF THE INVENTION

According to some embodiments, the present technology is directed to a device, comprising: a support cup that receives, supports, and seals a cap end of a toothpaste tube in substantial alignment with a central axis of the support cup, the cap end of the toothpaste tube is held in substantial alignment with the central axis of the support cup by contacting a continuous upper surface of the support cup, the cap end of the toothpaste tube and the continuous upper surface of the support cup forming a seal therebetween, sealing a cavity defined by a sidewall of the support cup.

In one embodiment, the cap end of the toothpaste tube is held in substantial alignment with the central axis of the support cup without contacting the sidewall of the support cup so as to create an annular spacing between an open terminal end of the cap end of the toothpaste tube and the sidewall.

In another embodiment, the support cup comprises a bottom surface that is configured to selectively engage with a horizontal counter surface in such a way that the central axis of the support cup is normal to the horizontal counter surface.

In yet another embodiment, the central axis of the support cup is disposed at an angle that is acute to a reference plane that is parallel to the horizontal counter surface.

In one embodiment, the device further comprises a base member, the support cup being received within a base member cavity formed into the base member.

In an additional embodiment, the support cup comprises a flange that overlaps and covers an opening of the base member cavity, the continuous upper surface being a part of the flange.

In one embodiment, a lower portion of the base has a curved profile forming a first foot disposed towards a forward part of the base and a second foot disposed towards a rearward part of the base.

In some embodiments, the support cup comprises a protrusion that extends upwardly from a bottom of the support cup.

In another embodiment, the protrusion comprises a hemi-spherical shape that cooperates with an open terminal end of the cap end of the toothpaste tube so as to seal the open terminal end.

In some embodiments, the device further includes a base member, the support cup being received within a base member cavity formed into the base member, wherein a bottom of the base member cavity comprises a protrusion having a hemi-spherical shape that cooperates spaces the sidewall of the support cup away from a sidewall of the base member cavity.

In one embodiment, the protrusion of the support cup and the protrusion of the base member cavity are centered on the central axis of the support cup.

In yet other embodiments, the sidewall of the support cup tapers from an opening of the support cup to a bottom of the support cup.

In some embodiments, the support cup comprises a means for supporting the cap end of the toothpaste tube so as to hold the toothpaste tube in substantial alignment with the central axis of the support cup.

In another embodiment, the support cup comprises a pair of resiliently biased arms that that extend from the sidewall of the support cup, substantially perpendicular to the central axis of the support cup, the pair of resiliently biased arms placing compressive forces on a threaded neck of the cap end of the toothpaste tube.

In one embodiment, the pair of resiliently biased arms is each configured to rest in thread grooves of the threaded neck of the cap end of the toothpaste tube.

In some embodiments, the device further comprises an additional cup that is configured to receive and retain a handle of a toothbrush.

In one embodiment, the support cup comprises: (i) a conical flange forming the continuous upper surface; and (ii) a stabilizing ring that extends beyond the conical flange wherein the support cup ring and a bottom of the support cup are coplanar with one another.

In yet another embodiment, the outwardly flared flange defines a peripheral surface that is disposed at an angle relative to the central axis of the support cup.

In some embodiments, the stabilizing ring is connected to a bottom of the support cup with a cylindrical web.

According to some embodiments, the present technology is directed to an assembly, comprising: (a) a support cup that receives, supports, and seals a cap end of a toothpaste tube in substantial alignment with a central axis of the support cup, the cap end of the toothpaste tube is held in substantial alignment with the central axis of the support cup by contacting a continuous upper surface of the support cup, the cap end of the toothpaste tube and the continuous upper surface of the support cup forming a seal therebetween, sealing a cavity defined by a sidewall of the support cup; and (b) a base member, the support cup being received within a base member cavity formed into the base member.

### BRIEF DESCRIPTION OF THE DRAWINGS

FIG. 1A is a perspective view of an example support cup.

FIG. 1B is a cross-sectional view of the example support cup.

FIG. 2 is a cross-sectional view of the example support cup, in spaced apart relationship with a tube of toothpaste.

FIG. 3 is a cross-sectional view of the example support cup, supporting the tube of toothpaste.

FIG. 4A is a perspective view of an example support cup of a support apparatus.

FIG. 4B is a partial cross sectional view of an example base member of a support apparatus.

FIG. 4C is a partial cross sectional view of an apparatus, illustrating the support cup of FIG. 4A being coupled with base member of FIG. 4B.

FIG. 4D is a cross sectional view of a support cup, with an open terminal end of a tube of toothpaste, contacting a support cup protrusion.

FIG. 5A illustrates a top-down view of a pair of resiliently biased arms of a support cup, in contact with a threaded neck of a tube of toothpaste.

FIG. 5B is a cross sectional side view of FIG. 5A.

FIG. 5C illustrates the removal of the tube of toothpaste from the pair of resiliently biased arms.

FIG. 6 illustrates a support cup where a tube of toothpaste rests on anchoring surfaces of the support cup.

FIGS. 7A-B collectively illustrate another example support cup with a straight sidewall (e.g., no flange).

FIG. 8 is a perspective, cross sectional view of another support cup that comprises a tapered sidewall, where the sidewall is disposed at an angle, rather than perpendicular to a bottom of the support cup.

FIG. 9 is a perspective view of an example support cup having an additional cavity for a toothbrush.

FIGS. 10A-D illustrate various other embodiments of support cups, constructed in accordance with the present technology.

FIG. 11 is a cross sectional view of an example support cup having a plurality of cavities that receive dental products, as well as a tube of toothpaste.

### DETAILED DESCRIPTION AND BEST MODE OF IMPLEMENTATION

In the following description, for purposes of explanation, numerous specific details are set forth in order to provide a thorough understanding of the disclosure. It will be apparent, however, to one skilled in the art, that the disclosure may be practiced without these specific details. In other instances, structures and devices are shown at block diagram form only in order to avoid obscuring the disclosure. It will also be apparent to one skilled in the art that the present invention may be practiced in other embodiments that depart from these specific details.

For context, the devices and apparatuses of the present technology provide support structures for holding dental accessories such as toothpaste tubes. In general, toothpaste tubes are re-sealable using a threaded cap that engages with a threaded neck of the toothpaste tube. The cap of some toothpaste tubes is small and requires dexterity and a certain level of fine motor skills in order to remove and replace the cap. Thus, small children and those with disabilities lacking the necessary dexterity and fine motor skills may have difficulty using tubes of toothpaste that have a cap.

The devices and apparatuses of the present technology provide a distinct advantage in storing a toothpaste tube in such a way that handling (and storing) the toothpaste tube, by an individual, can occur with the use of just one hand. This is particularly useful for young and physically limited individuals who are have difficulty using both hands to manipulate or use a toothpaste tube effectively.

Advantageously, the present technology provides devices and apparatuses that alleviate or mitigate these issues.

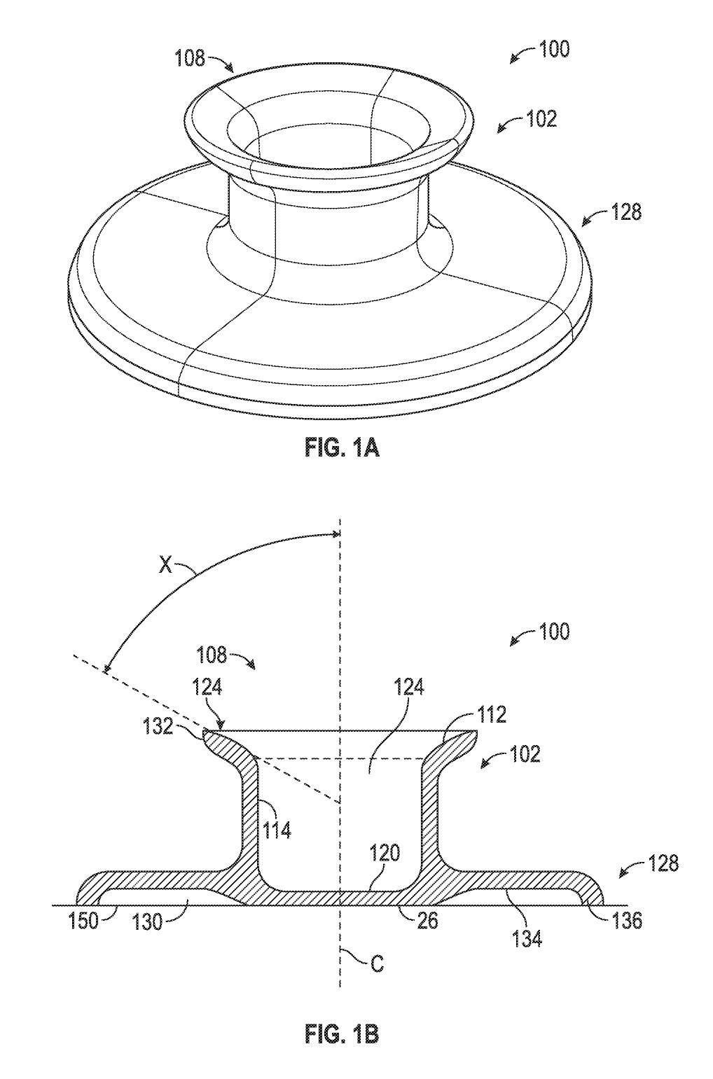

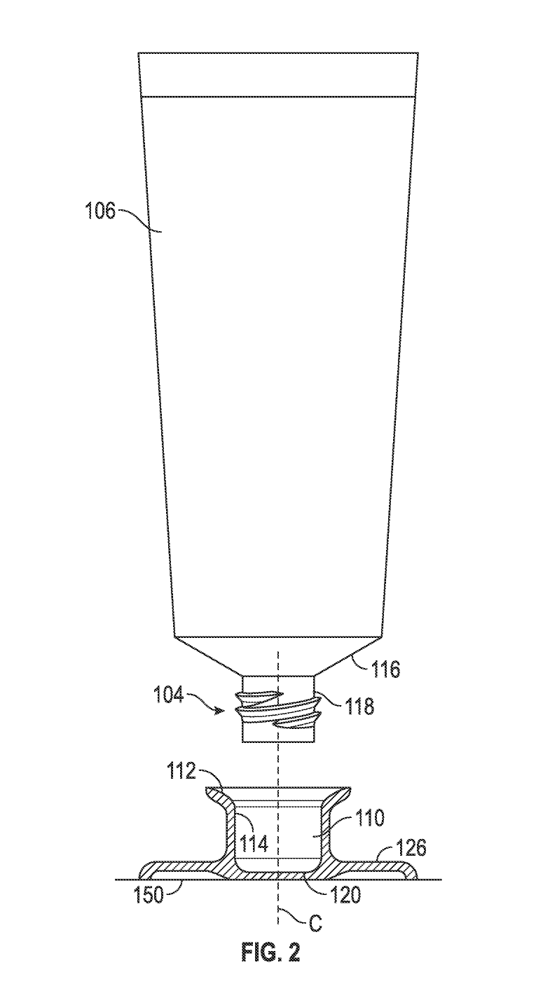

Referring now to FIGS. 1A-2 collectively, an example device 100, constructed in accordance with the present technology is illustrated. The device 100 is a support cup 102 that receives, supports, and seals a cap end 104 of a toothpaste tube 106 when inserted into the support cup 102. The support cup 102 can be constructed from any one, or combination, of a number of materials such as a plastic, a polymer, a resin, a metal, an alloy, a natural product (such as rubber), a composite or layering of materials, a glass, or other similar materials.

The manufacturing methods used to create the support cup 102 will depend upon the material chosen. For example, if the support cup 102 is manufactured from a thermoplastic polymer, the support cup 102 can be fabricated using one or more plastic thermoforming processes. If the support cup 102 is manufactured from a metal, the support cup 102 can be fabricated using casting, punching, or stamping.

A cavity 110 of the support cup 102 is configured to receive and support the cap end 104 of a toothpaste tube 106 using opening 108. This opening 108 is created by a continuous upper surface 112 that forms, for example, a flange.

The support cup 102 is defined geometrically and spatially by a central axis C.

The cap end 104 of the toothpaste tube 106 is held in substantial alignment with the central axis C of the support cup 102 when the cap end 104 contacts this continuous upper surface 112 of the support cup 102.

In one embodiment, the cap end 104 of the toothpaste tube 106 and the continuous upper surface 112 of the support cup 102 forms a seal when in a mating configuration. Thus, the cavity 110, which is defined by a sidewall 114 of the support cup 102, is sealed to prevent contaminates from contacting the cap end 104 of the toothpaste tube 106.

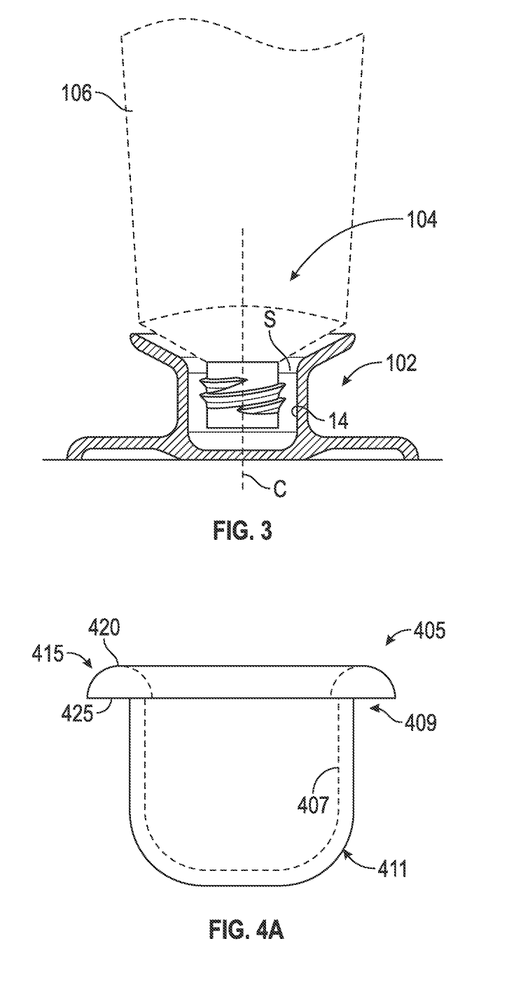

Referring briefly to FIG. 3, the cap end 104 of the toothpaste tube 106 is held in substantial alignment with the central axis C of the support cup 102 without contacting the sidewall 114 of the support cup 102 so as to create an annular spacing S between an open terminal end of the cap end 104 of the toothpaste tube 106 and the sidewall 114.

Returning to FIGS. 1A-2, in some embodiments, the cap end 104 of the toothpaste tube 106 comprises a conical shoulder 116 that provides a transition from the body of the toothpaste tube 106 down a threaded neck 118 of the toothpaste tube 106. This threaded neck 118 is configured to receive a cap (not shown).

In some embodiments, the support cup 102 has a bottom surface 120 that transitions to the sidewall 114. The sidewall 114 has a substantially cylindrical section 122 that extends along the central axis C and has a given diameter/radius that defines the size of the cavity 112A.

In one embodiment, the bottom surface 120 is configured to selectively engage with a horizontal counter surface 150 in such a way that the central axis C of the support cup 102 is normal (substantially perpendicular) to the horizontal counter surface 150.

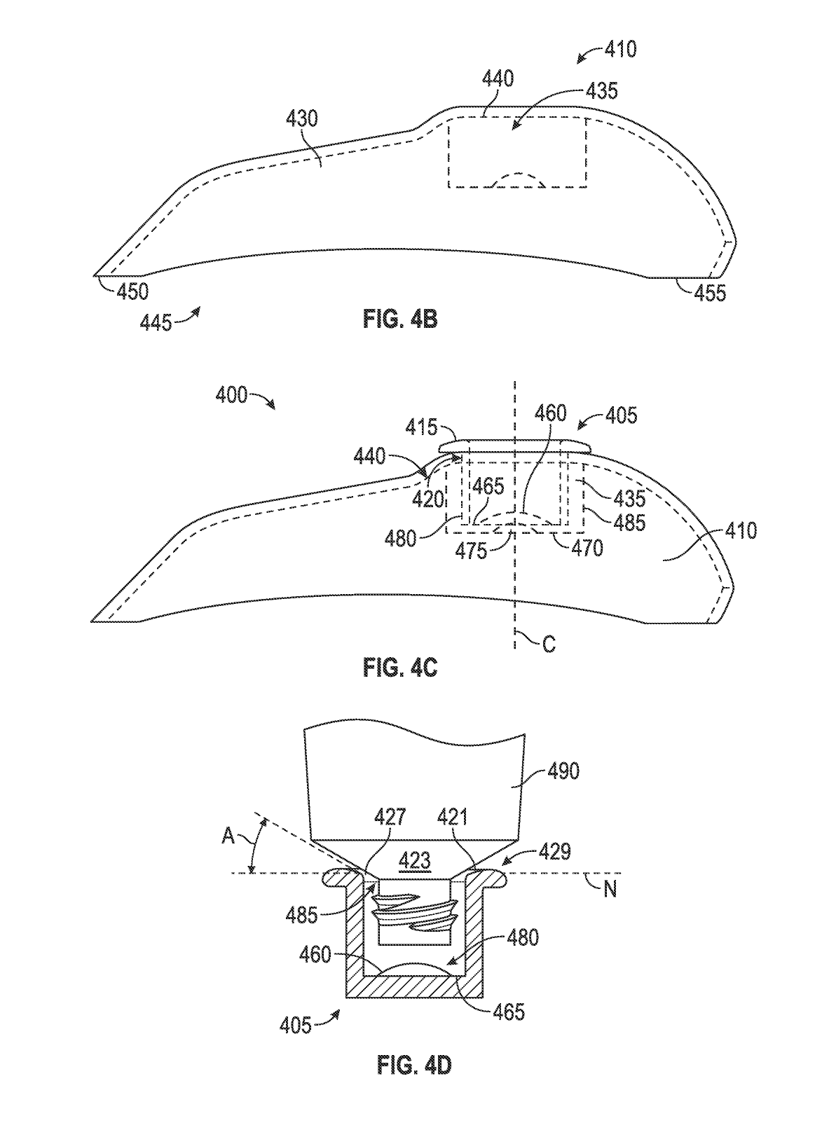

In accordance with the present disclosure, the sidewall 114 transitions to an outwardly flared flange section 124. The outwardly flared flange section 124 is disposed at an angle X that is acute relative to the central axis C of the support cup 102. The degree of this angle X can be varied to correspond to standard toothpaste tube shoulder profiles, such as the shoulder 116 of toothpaste tube 106. In one embodiment, the angle X is approximately 60 degrees (see 30 degree angle A of FIG. 4D). In another example, the angle X is approximately 45 degrees.

The angle X and length of the outwardly flared flange section 124 defines the continuous upper surface 112 of the support cup 102. In one embodiment, the outwardly flared flange section 124 is a conical flange incorporating the continuous upper surface 112.

In one embodiment, the support cup 102 rests not only on a bottom 126 of the support cup 102 but also a stabilizing ring 128 that extends beyond the outwardly flared flange section 124 (e.g., conical flange).

In some embodiments, the stabilizing ring 128 and bottom 126 of the support cup 102 are coplanar with one another. The stabilizing ring 128 forms a continuous foot 136 that is spaced apart from the bottom 126 of the support cup 102 at a distance, forming an annular pocket 130.

According to some embodiments, the stabilizing ring 128 extends beyond a terminal edge 132 of the outwardly flared flange section 124 (e.g., conical flange). In another embodiment, the stabilizing ring 128 is connected to the bottom 126 of the support cup 102 with a cylindrical web 134. In one embodiment, the cylindrical web 134 is a disk of material.

Referring now to FIG. 4A-C, an example apparatus 400 is illustrated. The apparatus comprises an example support cup 405 and base member 410. The support cup 405 is shaped similarly to the support cup 102 of FIGS. 1 and 2, with the exception that the support cup 405 does not comprise a support ring on the bottom of the cup. Also, support cup 405 has a flange 415 that forms a continuous upper surface 420 that is rounded in configuration. The flange 415 has a flat under surface 425.

In one embodiment, the support cup 405 has a sidewall 407 that tapers from an upper portion 409 of the support cup 405 toward a lower portion 411 of the support cup 405. In this embodiment, the sidewall 407 is narrower towards the lower portion 411.

In FIG. 4B, the base member 410 comprises a body 430 having a base member cavity formed 435 into the base member 410. The base member cavity 435 has an opening 440 that is sized to receive and retain the support cup 405.

In one embodiment, a lower portion 445 of the base member 410 has a curved profile forming a first foot 450 disposed towards a forward part of the base member 410 and a second foot 455 disposed towards a rearward part of the base member 410.

FIG. 4C illustrates the support cup 405 disposed in the base member cavity 435. The flange 415 of the support cup 405 covers the opening 440 of the base member cavity 435. Specifically, the flange 415 covers the edge of the opening 440 of the base member cavity 435. The flange 415 also supports the cap end of a toothpaste tube (similarly to the configuration of FIGS. 1 and 2).

In FIG. 4C, the support cup is illustrated as comprising a protrusion 460 that extends upwardly from a bottom 465 of the support cup 405. In one embodiment, the protrusion 460 comprises a hemi-spherical shaped dome that cooperates with an open terminal end 480 of the cap end 485 of the toothpaste tube 490 so as to seal the open terminal end 480 (FIG. 4D).

Also, a bottom 470 of the base member cavity 435 comprises a protrusion 475 having a hemi-spherical shape that spaces a sidewall 480 of the support cup 405 away from a sidewall 485 of the base member cavity 435.

In one embodiment, the protrusion 460 of the support cup 405 and the protrusion 460 of the base member cavity 435 are centered on the central axis C of the support cup 405.

In FIG. 4D, an angle A of a sidewall 421 of the support cup 405 is approximately 30 degrees (see FIG. 4D), relative to a normal plane N of the support cup 405. A neck 423 of the tube of toothpaste 490 is configured such that the neck 423 does not sit face-to-face with the sidewall 421 when the tube of toothpaste 490 is placed into the base member cavity. Indeed, a continuous upper surface 427 of the support cup 405, in this embodiment, would include only an upper portion 429, where the neck 423 contacts the sidewall 421, rather than an entirety, or a substantial part of the sidewall 421.

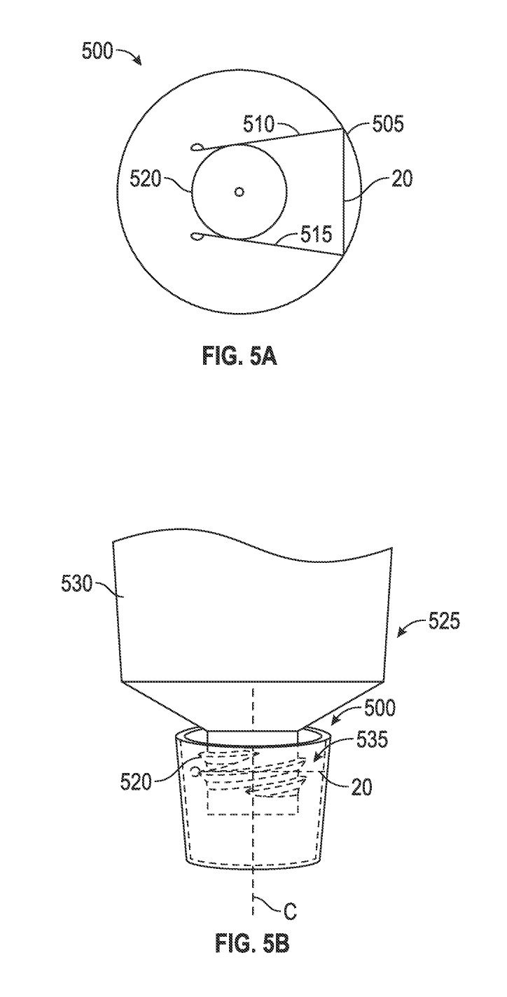

Referring now to FIGS. 5A-C, another example support cup 500 is illustrated. The support cup 500 has a sidewall 505 that comprises a pair of resiliently biased arms 510 and 515 that that extend from the sidewall 505 of the support cup 500.

In one embodiment, the pair of resiliently biased arms 510 and 515 extends substantially perpendicular to the central axis C of the support cup 500. The pair of resiliently biased arms placing compressive forces on a threaded neck 520 of a cap end 525 of a toothpaste tube 530.

Each of the pair of resiliently biased arms 510 and 515 comprises a terminal end, such as terminal end 535 that is rounded to facilitate insertion of the cap end 525 between the pair of resiliently biased arms 510 and 515.

It will be understood that pair of resiliently biased arms 510 and 515 is each configured to rest in thread grooves, such as thread groove 535 of the threaded neck 520 of the cap end 525.

The threaded neck 520 of the cap end 525 can be removed from the pair of resiliently biased arms 510 and 515 by tilting the toothpaste tube at an angle relative to the central axis C of the support cup 500.

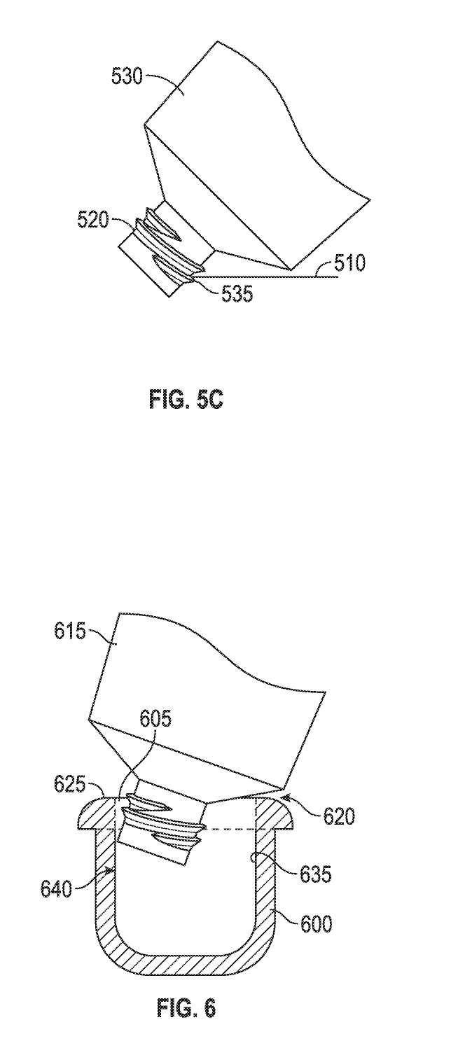

Referring now to FIG. 6, in one embodiment, a support cup 600 is illustrated. The support cup 600 is identical to the support cup 500 of FIG. 5. A cavity 605 of the support cup 600 is sized such that a cap end of a toothpaste tube 615 contacts a first anchoring surface 620. The first anchoring surface 620 is a point on a continuous upper surface 625 of the support cup 600. The threaded neck 630 of the toothpaste tube 610 contacts a sidewall 635 of the support cup 600 at a second anchoring surface 640. Thus, the toothpaste tube 610 can be supported, even when the toothpaste tube 610 is not in alignment with the central axis C of the support cup 600.

The support cup 600 can be used with a base member, such as the base member 410 of FIG. 4B.

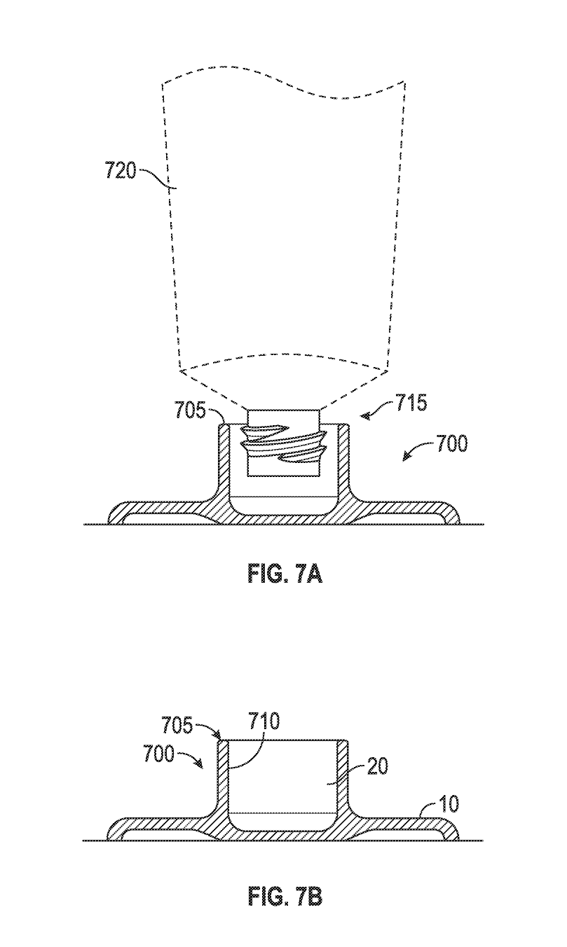

Referring now to FIGS. 7A-7B, another example support cup 700 is illustrated. The support cup 700 is similar to the support cup of FIGS. 1 and 2, with the exception that the support cup 700 does not have a flange. The support cup 700 terminates at the top with an upper edge 705 of a sidewall 710. The end 715 of a toothpaste tube 720 contacts the upper edge 705 of the sidewall 710, in use.

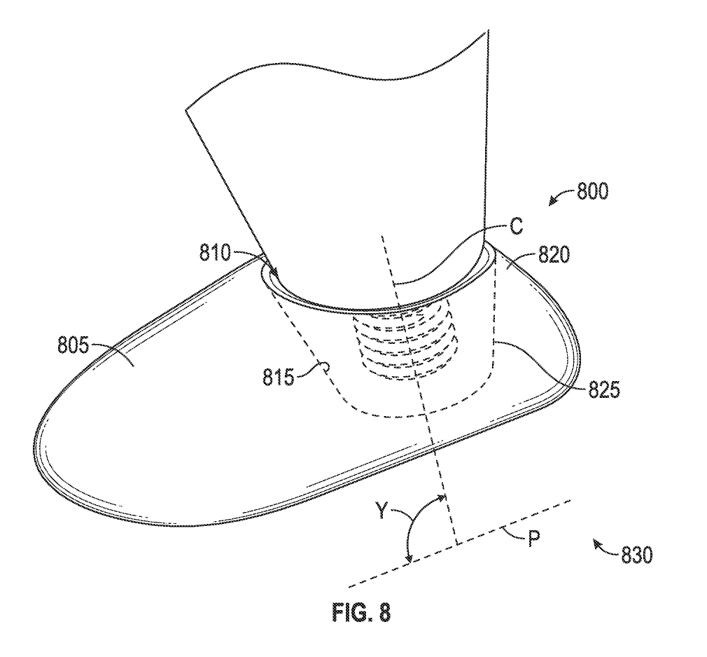

In FIG. 8A, another example support cup 800 is illustrated. The support cup 800 comprises a body 805 with a cavity 810 that is defined by a sidewall 815. The sidewall 815 tapers from an opening 820 of the support cup 800 to a bottom 825 of the support cup 800.

Also, a central axis C of the support cup 800 is disposed at an angle Y that is acute to a reference plane P that is parallel to the horizontal counter surface 830.

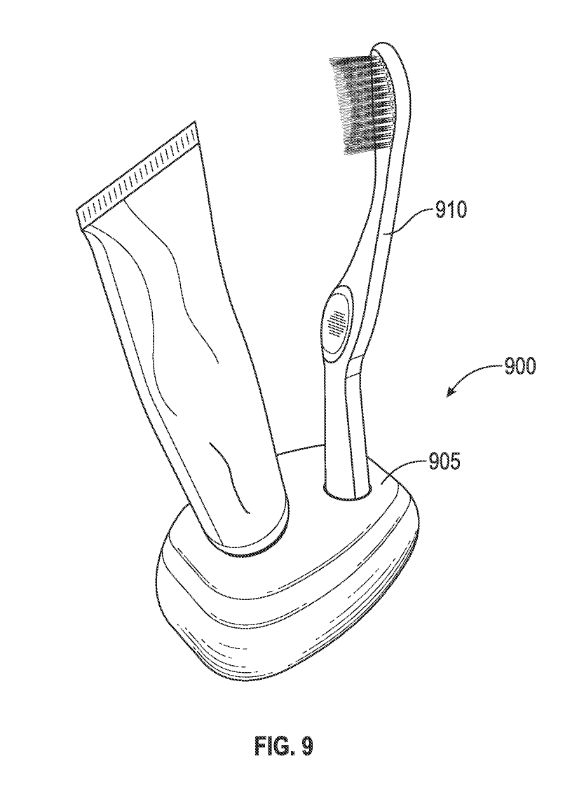

FIG. 9 is another example support cup 900 that is similar to the support cup 800 of FIG. 8 with the addition of a second cavity 905 that receives and retains a handle of a toothbrush 910.

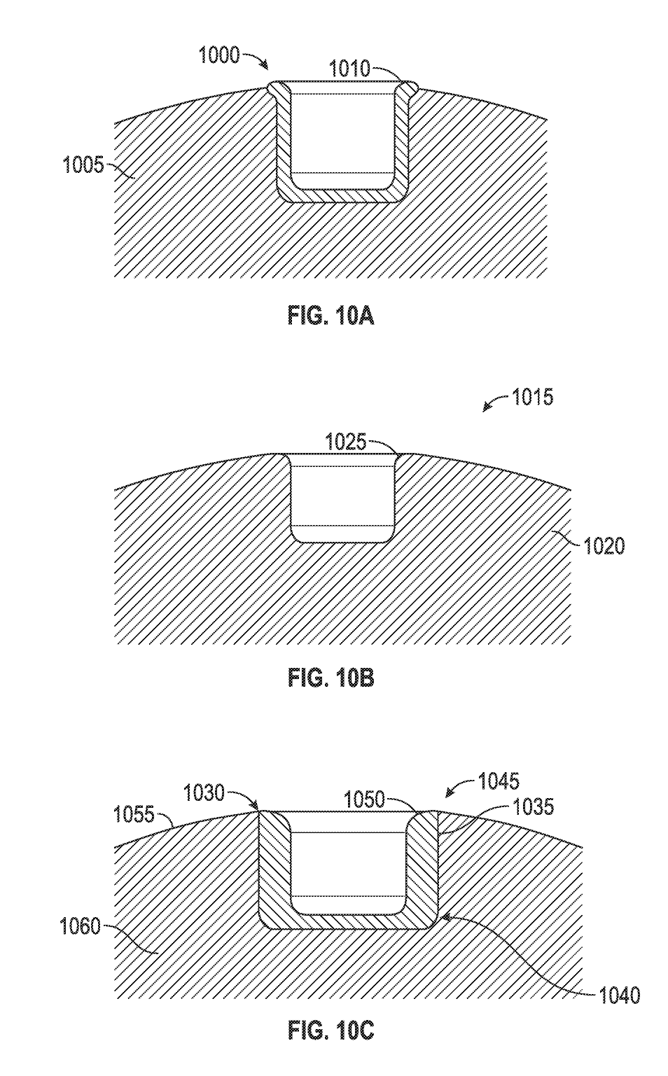

FIGS. 10A-E individually illustrates various embodiments of example support devices and assemblies. For example, FIG. 10A illustrates an example support cup 1000 that is integrated into a base member 1005. The support cup 1000 comprises a crowned upper edge 1010 (e.g., continuous upper surface). The support cup 1000 can also be selectively removable from the base member 1005.

In FIG. 10B, a support cup 1015 with a wide base 1020 is illustrated. The support cup 1015 comprises a continuous upper surface 1025.

In FIG. 10C, a support cup 1030 is illustrated. An outer sidewall 1035 of the support cup 1030 is cylindrical, fitting into a cylindrical base cavity 1040. An upper part 1045 of a continuous upper surface 1050 of the support cup 1030 matches with and transitions to an outer surface 1055 of a base member 1060.

In FIG. 10D, a support cup 1065 with a wide base 1070 is illustrated. The support cup 1065 comprises a continuous upper surface 1075 that is created by putting a chamfered edge on an opening 1080 of the support cup 1065.

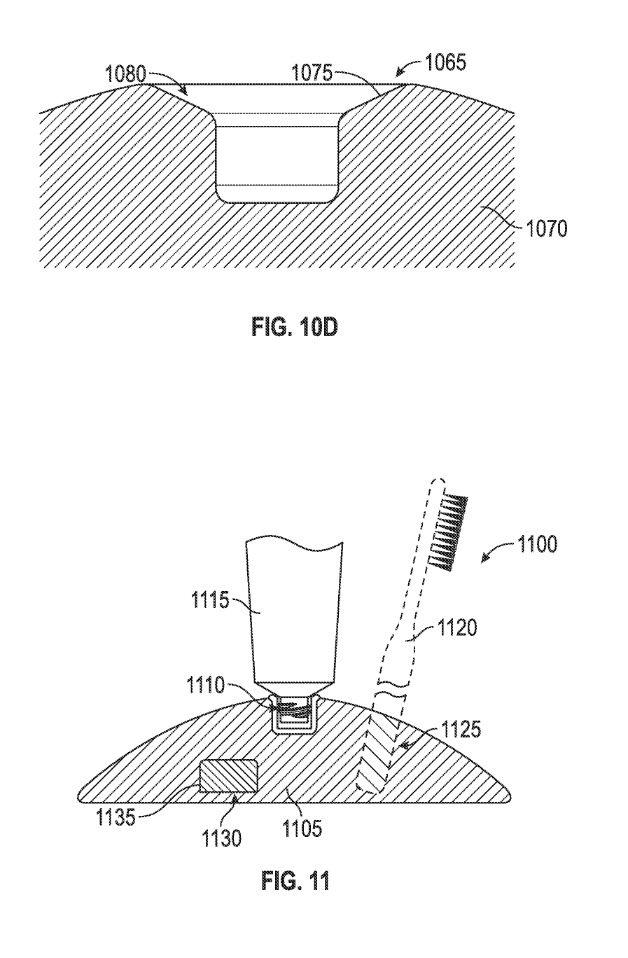

Referring now to FIG. 11, anther example support cup 1100, formed into a support base 1105 is illustrated. The support base 1105 is configured to sit flat on a surface, such as a countertop. A cap end 1110 of toothpaste tube 1115 is inserted into the support cup 1100. A toothbrush 1120 is inserted into a second support cup 1125. The support base 1105 also has a cutout or notch 1130 for receiving a dental floss container 1135. It will be understood that the support base 1105 can be manufactured with additional or fewer cutouts, notches, grooves, and the like to support additional types and sizes of dental care products.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “mechanically connected,” etc., are used interchangeably herein to generally refer to the condition of being mechanically/physically connected (either directly or indirectly). It is further noted that various figures (including component diagrams) shown and discussed herein are for illustrative purpose only, and are not drawn to scale.

It is to be understood that the described embodiments of the invention are illustrative only and that modifications thereof may occur to those skilled in the art. Accordingly, this invention is not to be regarded as limited to the embodiments disclosed, but is to be limited only as defined by the appended claims herein. It will further be understood that any features described in relation to any particular embodiment may be featured in combinations with other embodiments, for avoidance of doubt.

While FIGS. 1-11 are described independently from one another, FIGS. 1-11 can also be referred to collectively for purposes of context and clarity of explanation. That is, a description of a particular figure may reference portions of other figures, either using explicit call outs to other figures or by the use of reference signals that are present in other figures. In some instances groups of figures may be referred to collectively. Also, it is contemplated that individual components of various embodiments can be combined together with other embodiments.

### REFERENCES (INCORPORATED HEREIN BY REFERENCE)

Please find references below.

1. A device, comprising: a support cup that receives, supports, and seals a cap end of a toothpaste tube in substantial alignment with a central axis of the support cup, the cap end of the toothpaste tube is held in substantial alignment with the central axis of the support cup by contacting a continuous upper surface of the support cup, the cap end of the toothpaste tube and the continuous upper surface of the support cup forming a seal therebetween, sealing a cavity defined by an inner sidewall of the support cup, wherein the inner sidewall forms a flat and continuous cylinder that extends between the continuous upper surface and a bottom inner surface of the support cup.

2. The device according to claim 1, wherein the cap end of the toothpaste tube is held in substantial alignment with the central axis of the support cup without contacting the sidewall of the support cup so as to create an annular spacing between an open terminal end of the cap end of the toothpaste tube and the sidewall.

3. The device according to claim 1, wherein the support cup comprises a bottom surface that is configured to selectively engage with a horizontal counter surface in such a way that the central axis of the support cup is normal to the horizontal counter surface.

4. The device according to claim 3, wherein the central axis of the support cup is disposed at an angle that is acute to a reference plane that is parallel to the horizontal counter surface.

5. The device according to claim 4, further comprising a base member, the support cup being received within a base member cavity formed into the base member, wherein the base member selectively engage horizontal counter surface rather than the bottom surface of the support cup.

6. The device according to claim 5, wherein the support cup comprises a flange that overlaps and covers an opening of the base member cavity, the continuous upper surface being a part of the flange.

7. The device according to claim 5, wherein a lower portion of the base member has a curved profile forming a first foot disposed towards a forward part of the base and a second foot disposed towards a rearward part of the base.

8. The device according to claim 1, wherein the support cup comprises a protrusion that extends upwardly from a bottom of the support cup.

9. The device according to claim 8, wherein the protrusion comprises a hemi-spherical shape that cooperates with an open terminal end of the cap end of the toothpaste tube so as to seal the open terminal end.

10. The device according to claim 1, further comprising a base member, the support cup being received within a base member cavity formed into the base member, wherein a bottom of the base member cavity comprises a protrusion having a hemi-spherical shape that spaces the sidewall of the support cup and away from a sidewall of the base member cavity.

11. The device according to claim 10, wherein the support cup comprises a protrusion that extends upwardly from a bottom of the support cup, and further wherein the protrusion of the support cup and the protrusion of the base member cavity are centered on the central axis of the support cup.

12. The device according to claim 10, wherein the sidewall of the support cup tapers from an opening of the support cup to a bottom of the support cup.

13. The device according to claim 1, wherein the support cup comprises a means for supporting the cap end of the toothpaste tube so as to hold the toothpaste tube in substantial alignment with the central axis of the support cup.

14. The device according to claim 1, wherein the support cup comprises a pair of resiliently biased arms that that extend from the inner sidewall of the support cup, substantially perpendicular to the central axis of the support cup, the pair of resiliently biased arms placing compressive forces on a threaded neck of the cap end of the toothpaste tube.

15. The device according to claim 14, wherein the pair of resiliently biased arms is each configured to rest in thread grooves of the threaded neck of the cap end of the toothpaste tube.

16. The device according to claim 1, further comprising an additional cup that is configured to receive and retain a handle of a toothbrush.

17. The device according to claim 1, wherein the support cup comprises:
a conical flange forming the continuous upper surface; and
a stabilizing ring that extends beyond the conical flange wherein the support cup ring and a bottom of the support cup are coplanar with one another.

18. The device according to claim 17, wherein the conical flange defines a peripheral surface that is disposed at an angle relative to the central axis of the support cup.

19. The device according to claim 17, wherein the stabilizing ring is connected to the bottom of the support cup with a cylindrical web.

20. An assembly, comprising:
(a) a support cup that receives, supports, and seals a cap end of a toothpaste tube in substantial alignment with a central axis of the support cup, the cap end of the toothpaste tube is held in substantial alignment with the central axis of the support cup by contacting a continuous upper surface of the support cup, the cap end of the toothpaste tube and the continuous upper surface of the support cup forming a seal therebetween, sealing a cavity defined by an inner sidewall of the support cup, wherein the inner sidewall forms a flat and continuous cylinder that extends between the continuous upper surface and a bottom inner surface of the support cup; and
(b) a base member, the support cup being received within a base member cavity formed into the base member.
